(19) United States
(12) Patent Application Publication
(10) Pub. No.: US 2004/0089605 A1
(43) Pub. Date: May 13, 2004

(54) Reverse osmosis liquid purification system and method

(76) Inventors: Harry Brandt, El Macero, CA (US); Tibor Nemeth, Molnlycke (SE)

Correspondence Address: Bradley P. Heisler, Heisler & Associates, Suite 300, 3017 Douglas Blvd., Roseville, CA, 95661, US

(21) Appl. No.: 10/336,327

(22) Filed: Jan. 2, 2003

Related U.S. Application Data
(60) Provisional application No. 60/425,052, filed on Nov. 8, 2002.

(51) Int. Cl. B01D 61/02; B01D 61/08; B01D 61/12

(52) U.S. Cl. 210/652; 210/739; 210/85; 210/87; 210/97; 210/109; 210/110; 210/134; 210/143; 210/321.6

(57) ABSTRACT

A water purification system and method based on reverse osmosis is provided. An inlet of supplied water to be purified is driven by a first flow propelling device which drives inlet supplied water flow to an upstream side of a membrane. An outlet of reject water from the upstream side of the membrane is driven by a second flow propelling device. The first and second flow propelling devices are powered by a common driving shaft or otherwise linked or controlled so that a ratio of inlet flow to outlet flow is maintained constant and a rate of permeate flow from a downstream side of the membrane is also kept constant.

### BACKGROUND OF THE INVENTION

Purification of water by reverse osmosis generally involves forcing pressurized salt water, or water with other dissolved solids therein, through an osmotic membrane.

Salt or other dissolved solid containing feed water is introduced by means of a high pressure pump to the upstream side of a permeable membrane. The desalted product, also called permeate, is removed from the downstream side of the membrane. It is a known fact that the permeate flow rate is much dependent upon the temperature of the water and the net driving pressure. All manufacturers' data are given for a reference temperature of 25° C. Lowering of the temperature to about 10° C. usually means that the permeate flow is halved.

The driving pressure, strictly speaking the net driving pressure, is the difference between the system pressure and the osmotic pressure. The system pressure is the pressure across the membrane. The osmotic pressure is determined by and is a function of the concentration of all the salts, inorganic ions, organic matter, and other substances that are present in the water adjacent to the upstream surface of the membrane.

As the water permeates through the membrane, almost all (in most cases more than ninety-nine percent) of these substances remain at the upstream side of the membrane, increasing the concentration of substances at the upstream side. This concentration increase causes the osmotic pressure to be increased. The net driving pressure is thus reduced and consequently the permeate flow is reduced. If the equipment were moved and the salt-containing feed water were to have a concentration of salts that differs from the feed water to the prior location, then the salt concentration at the surface of the membrane will change. This change brings with it a change of the osmotic pressure and thus a change of the net driving pressure resulting in a different permeate flow. If the concentration of salts and other substances in the feed water is increased the osmotic pressure is increased. As a result, the net driving pressure is reduced and the permeate flow is reduced.

All known prior art conventional systems which use the principle of reverse osmosis produce a permeate flow rate that varies both with the temperature (direct proportionality) and with the salt content of the feed water (reverse proportionality). These variations determine the osmotic pressure which when increased causes a decrease of the net driving pressure (the difference between the pressure of the system and the osmotic pressure given by the salt content). There are also other flow limiting factors. All together this brings with it that one and the same configuration of a conventional reverse osmosis system produces different permeate flow rates when the salt content or the temperature of the feed water is changed. Accordingly, a need exists for a reverse osmosis system that maintains a constant permeate flow rate.

### SUMMARY OF THE INVENTION

The method of purifying water or other solvents by removal of dissolved substances according to this invention provides a constant flow rate of produced permeate independent of the temperature and the existing osmotic pressure as the system pressure and consequently the net driving pressure are adapted to the existing conditions. Flow is kept constant by means of a volume flow pump which always gives substantially the same fluid volume per unit time, i.e. the same fluid flow rate. When an increased resistance to the flow is encountered, the pressure is increased, and vice versa, but the fluid flow rate remains constant.

By applying the flow means, such as pumps, and driving these in speeds which remain proportional to each other in accordance with the invention, the relation between the volume rate of salt-containing feed water and the volume rate of reject water is fixed. The volume rate of permeate flow thus also remains fixed. Substantially all the substances which have been rejected by the membrane are in the reject water.

### OBJECTS OF THE INVENTION

Accordingly, a primary object of the present invention is to provide a method for purification of salt or other dissolved substances containing feed water by reverse osmosis by maintaining conditions of operation according to the method which maintains a constant volume rate of salt-containing feed water to produce a constant volume rate of product water, which by reverse osmosis is named permeate, which is independent of the prevailing osmotic pressure and/or the temperature of the water or any other flow limiting factors, i.e. the polarization concentration, scaling, fouling, etc.

Another object of the present invention is to provide a system which compensates for flow limiting factors so that the permeate is produced at a constant flow rate.

Another object of the present invention is to keep an inflow rate and outflow rate ratio constant around the membrane, such that permeate flow rates are kept constant.

Other further objects of the present invention will become apparent from a careful reading of the included figure, the claims and detailed description of the invention.

### BRIEF DESCRIPTION OF THE DRAWINGS

FIG. 1 is a schematic diagram of the reverse osmosis system of this invention according to a preferred embodiment. The figure shows a single reverse osmosis membrane assembly. It is evident that other membrane assembly configurations, such as several membrane assemblies in series, or in parallel, or both in series and in parallel are also included within the scope of this invention. The Figure shows three flow means, such as positive displacement pumps, mounted on a single shaft to provide a fixed relationship between the flow rates of the three flow means. As explained in a later section of this patent description, other means are possible to drive the flow means to produce a fixed relationship between the flow rates of each of the flow means.

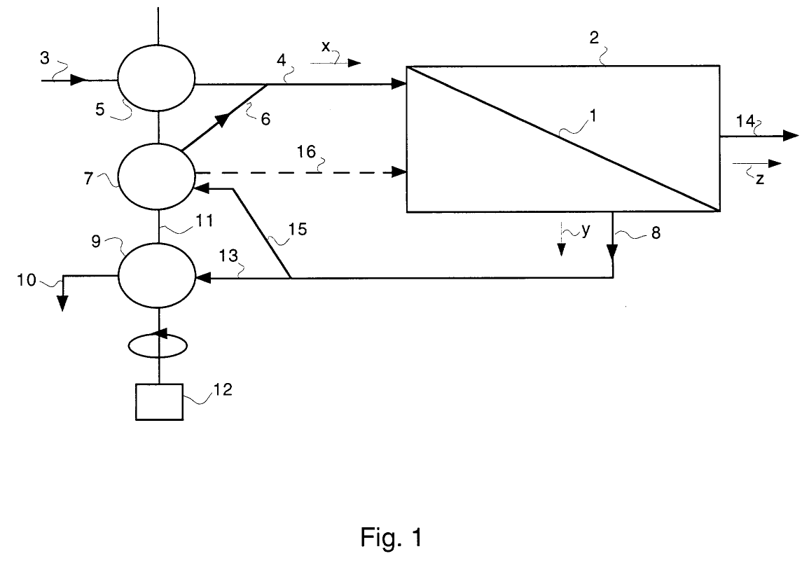

### DESCRIPTION OF THE PREFERRED EMBODIMENT

The primary principle upon which this invention is based is conservation of mass. The sum of all flows into the region upstream of the membrane 1 equals the sum of all outflows from this region, including outflow through the membrane (see figure). To keep the flow rate of permeate 14 from the downstream side of the membrane 1 constant, the flow rates (x) of all feed water 4 (and optionally 16) into the region upstream of the membrane 1 and the flow rate (y) of feed water 8 out of the region are held constant. These flow rates (x, y) thus dictate what the flow rate (z) of permeate 14 will be. In equation form, conservation of mass requires that at the region upstream of the membrane 1,

x−y=z (equation 1)

By keeping x and y constant z is kept constant. Thus, the permeate flow rate (z) is maintained at a constant rate.

The permeate yield rate shall have a defined relation to the recirculating flow rate so that the border layer at the upstream surface of the membrane is reduced. In the border layer there are those substances which have been rejected from the water which has passed through the membrane, giving the product water flow, or permeate flow, which is taken out through the conduit 14. In one embodiment, positive displacement pumps are used as a means to control flow rates to introduce the salt or other dissolved substance containing feed water into the membrane assembly 2.

Positive displacement pumps produce a substantially constant volume flow per unit time regardless of the pressure of the system (other than the minimal changes in leakage rates around the piston or other flow inducing equipment, depending upon the design of the pumps). By putting positive displacement pumps or other flow rate control means 5, 7 and 9 on a common driving shaft 11 it is achieved that the relation or ratio between the volume rate of the supplied feed water 3 and the volume rate of the reject water 10, containing the rejected substances, is substantially fixed. It is then achieved that the so called polarization concentration can be controlled by keeping the recirculating flow rate at a proper level and so control and avoid or reduce the risks for scaling (precipitates blocking or plugging the membrane) or fouling (biofilm growing on the surface of the membrane).

The theoretical computations are based upon ideal conditions where the permeate flow rate is infinitesimal or as close to zero as possible. In practice one desires to have test results as close to ideal conditions as possible and one accepts a low recovery rate, usually around five percent. The recovery rate is defined as the ratio between the permeate flow rate and the feed water flow rate. Commercial units operate at less than fifty percent water recovery rate. According to the method of the invention the units operate with an extremely high water recovery rate of up to eighty percent and using feed water of low salt concentration (salt content below 100 mg/l) a continuous recovery rate of ninety percent has been maintained. This means that at the permeate outlet 14, ninety percent of the supplied feed water 4 has passed through the membrane 1. These conditions are made possible by arranging for flow recirculation and thereby maintaining the flow speed and pressure of the water at the upstream surface of the membrane 1.

As shown in the figure there is an element 1 made from a reverse osmosis membrane and placed into a container 2. The feed water 3 which is to be purified is supplied at constant volume flow per unit time (i.e. flow rate) and by the pump or other flow rate control means 5 either by a conduit 4 leading directly to the container 2 or together with the flow 6 from a second recirculating pump or other flow rate control means 7. The outflow from the second flow rate control means 7 is either taken through the conduit 6 to be mixed with the feed water 4 or alternatively taken directly to the container 2 via the conduit 16. Thus, the feed water region adjacent the upstream side of the membrane 1 can be fed by one or two streams. The inflow to the flow rate control means 7 is unpurified water which, via the conduit 15, is returned from the outlet 8 of the container 2. Some of the water from the outlet 8 of the container 2, upstream of the membrane 1, is supplied through the conduit 13 to a discharge pump or other discharge flow rate control means 9, which at a fixed predetermined proportion of the volume rate of the feed water 4 diverts a constant volume fraction of reject water through conduit 10. While the container 2 is shown with a single membrane 1 therein, this is merely an illustrative schematic representation of the membrane 1 and associated adjacent regions. In practice, multiple membranes could be provided in series or in parallel (or both) and still function according to this invention.

The flow rate control means 5, 7, 9 are preferably positive displacement pumps that each produce a constant volume flow per unit time at a particular pump shaft speed. These pumps 5, 7, 9 can be reciprocating direct or indirect acting, such as piston pumps or gear pumps. These pumps could also be peristaltic, gerotor or rotary style pumps, as well as any other known or future developed pump type, and especially pumps that produce a known volume rate of fluid output as a function of pump shaft speed and independently of operating pressure. By mounting the flow generating means 5, 7 and 9 on a common driving shaft 11 the relation between the volume of feed water per unit time supplied through conduit 3 and by the flow means 5 and the volume per unit time of the reject water, containing the rejected substances and flowing through discharge conduit 10, is fixed. If the shaft 11 changes speed, the relation or ratio stays constant, but the flow rates would change proportionate to each other. The shaft 11 is driven by a motor 12 at a regulated speed so that the volume per unit time of permeate is regulated and controlled.

### EXAMPLE

The purifier is to produce 6 liters of purified water (permeate) per minute. This requires a high rate membrane 1 with a surface area of about five square meters using reverse osmosis design criteria common in the art. If the purifier is to give a recovery rate of water of fifty percent, the feed water 4 flow rate (x), also called the rate of delivery (x), is provided at 12 liters per minute by the flow rate control means 5, such as the feed water delivery pump 5. In the simplest form of this invention, the outlet 8 water flow rate (y), also called the rate of removal (y), is provided at 6 liters per minute by the flow rate control means 9, such as the feed water removal pump 9, and no recirculation occurs through the conduit 15 and flow rate control means 7. Hence the discharge conduit 10 removes 6 liters per minute from the system. To conserve mass according to equation 1, the permeate flow rate (z) through the membrane 1 is held at 6 liters per minute.

A slightly more complex variation involves recirculating a portion of outlet 8 water flow through the flow rate control means 7 along conduit 15 and conduit 6 (or conduit 16). Note that the amount of recirculation does not influence equation 1 because it adds equally to the quantity of both feed water flow rate (x) and outlet flow rate (y). The greater the recirculation the greater the flow rate through the container 2 upstream of the membrane 1. Preferably, the desired amount of recirculation is optimized when the system is designed and then the flow rate control means 7 is set to deliver this rate of recirculation and then maintained fixed at this desired rate. Alternatively, the recirculation rate could be driven separately from the feed water and discharge flow rate control means 5, 9 with the feed water and discharge flow rate control means 5, 9 kept constant to keep the permeate flow rate (z) constant through the permeate conduit 14. Where the water is already rather pure or where membranes of large size or highest quality are provided, the recovery rate can be ninety to ninety-five percent, and potentially for the highest quality membranes above ninety-nine percent.

In another embodiment of this invention, the positive displacement pumps (5, 7, 9) are connected by mechanical couplings that consist either of multiple shafts driven by gears, or shafts connected by chain drives and sprockets, or by shafts connected by timing belts and pulleys, or by a combination of these or related mechanical energy transfer devices to produce a fixed relationship between the volume rate of feed water supplied to the membrane 1 through conduit 3 by pump 5 and the volume rate of the reject water, containing the rejected substances, that is pumped through conduit 10 by pump 9. While pump 7 optionally and preferably produces a fixed volume rate of fluid recirculation by accepting fluid through conduit 15 and delivering this fluid to either conduit 6 or to conduit 16, or to both conduits 6 and 16, the pump 7 could be omitted or be provided in the form of a flow inducing device that can have the flow rate varied to alter the amount of recirculation without altering the rates of inflow and outflow upstream of the membrane.

In another embodiment of this invention, the flow rate control means 5, 7, 9 are driven by individual constant speed motors to produce a fixed relationship between the volume rate of salt-containing feed water supplied through conduit 3 by flow rate control means 5 to the membrane and the volume rate of the reject water, containing the rejected substances that is pumped through conduit 10 by flow rate control means 9, while flow rate control means 7 optionally produces a fixed volume rate of fluid recirculation by accepting fluid through conduit 15 and delivering this fluid to either conduit 6 or to conduit 16 or to both conduits 6 and 16.

In another embodiment of this invention, the permeate outlet 14 is directed to a vessel with level control. A flow rate control means takes permeate flow from the vessel at a predetermined volume flow rate. The level control provides speed control of both the flow rate control means 5 in the feed water flow line 4 and optionally the flow rate control means 9 in the reject water line 10 to produce a fixed relationship between the volume rate of feed water supplied through conduit 3 by the flow rate control means 5 to the membrane and the volume rate of the reject water, containing the rejected substances that are pumped through conduit 10 by flow rate control means 9, while flow rate control means 7 produces a fixed volume rate of fluid recirculation by accepting fluid through conduit 15 and delivering this fluid to either conduit 6 or to conduit 16, or to both conduits 6 and 16.

In another embodiment of this invention, one of several possible flow measuring devices, such as a venturi with a differential pressure gauge, or an orifice with a differential pressure gauge, or any one of a number of commercially available flow measuring devices, are installed in the permeate conduit 14 and in the feed water conduit 3, 4. The measuring devices are coupled to a speed controller driving both the flow rate control means 5 in the feed water flow line 3 and the flow rate control means 9 in the reject water line 10 to produce a fixed relationship between the volume rate of feed water supplied through conduit 3 by flow rate control means 5 to the membrane 1 and the volume rate of the reject water that flows through conduit 10 by flow rate control means 9. The flow rate control means 7 produces a fixed volume rate of fluid recirculation by accepting fluid through conduit 15 and delivering this fluid to either conduit 6 or to conduit 16, or to both conduits 6 and 16. In this embodiment, flow rate control means 5 and 9 can either be positive displacement pumps or centrifugal pumps, or can be a combination of these flow rate control means or other devices capable of causing fluid in a conduit to move at a controllable flow rate through the conduit.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows rotating, sliding or other relative motion while still providing some form of attachment.

What is claimed is:

1- A system for purification of water, comprising in combination:
a permeable reverse osmosis membrane having an upstream side and a downstream side;
an inflow conduit adapted to deliver feed water to be purified to a feed water region adjacent said upstream side of said membrane;
said inflow conduit including means to control a flow rate of the feed water passing through said inflow conduit;
a permeate conduit adapted to draw permeate away from said downstream side of said membrane;
an outlet conduit adapted to draw feed water from said feed water region;
said outlet conduit including means to control a flow rate of the feed water passing through said outlet conduit; and
said means to control a flow rate of the feed water passing through said inflow conduit and said means to control a flow rate of the feed water passing through said outlet conduit are each adapted to maintain their respective flow rates at a substantially constant ratio relative to each other.

2- The system of claim 1 wherein each said means to control a flow rate includes a separate pump.

3- The system of claim 2 wherein each said pump is a positive displacement pump.

4- The system of claim 3 wherein each said pump is mechanically coupled together so that the speed of each pump maintains a constant proportion relative to the speed of the other pump.

5- The system of claim 4 wherein each said pump is coupled to a common drive shaft.

6- The system of claim 2 wherein each said pump includes a flow rate controller thereon;
wherein flow rate sensors are included in said inlet conduit and said outlet conduit; and
said flow rate controller adapted to control flow rates of said pumps to keep flow rates sensed by said flow rate sensors at a constant ratio relative to each other.

7- The system of claim 2 wherein a recirculation conduit is provided between said outlet conduit and said feed water region to return feed water from said outlet conduit to said feed water region.

8- The system of claim 7 wherein said recirculation conduit includes a pump thereon.

9- The system of claim 8 wherein said pump on said recirculation conduit is a positive displacement pump having a speed which is maintained at a constant ratio relative to speeds of said pumps of said flow rate control means of said inlet conduit and said flow rate control means of said outlet conduit.

10- The system of claim 1 wherein said means to control a flow rate of the feed water passing through said inflow conduit is adapted to maintain a flow rate greater than a flow rate through the outlet conduit.

11- A method for purification of water including the steps of:
providing a permeable reverse osmosis membrane having an upstream side and a downstream side;
delivering feed water to be purified to a feed water region adjacent the upstream side of the membrane;
allowing permeate to flow away from the downstream side of the membrane;
removing feed water from the feed water region through an outlet separate from the membrane; and
controlling a rate of delivery of feed water into the feed water region and a rate of removal of feed water out of the feed water region through the outlet to keep a substantially constant ratio between the rate of delivery and the rate of removal.

12- The method of claim 11 wherein said controlling step includes the step of providing a feed water delivery pump oriented to deliver feed water into the feed water region adjacent the upstream side of the membrane and a feed water removal pump oriented to remove feed water from the feed water region through the outlet on the upstream side of the membrane.

13- The method of claim 12 wherein said controlling step includes the step of keeping a flow rate of the feed water delivery pump greater than a flow rate of the feed water removal pump.

14- The method of claim 12 including the further step of sizing the feed water delivery pump and the feed water removal pump differently, but moving the feed water delivery pump and the feed water removal pump at a common speed.

15- The method of claim 14 including the further step of selecting the feed water delivery pump and the feed water removal pump to both be positive displacement pumps.

16- The method of claim 15 including the further step of driving the feed water delivery pump and the feed water removal pump by a common shaft.

17- The method of claim 12 wherein said controlling step includes the step of providing a control system for controlling flow rates of said feed water delivery pump and said feed water removal pump, said control system adapted to maintain a constant ratio between the flow rate of the feed water delivery pump and the flow rate of the feed water removal pump.

18- A system for purification of a liquid solution including a solvent having dissolved substances therein, the system comprising in combination:
a membrane through which the solvent can pass but the dissolved substances cannot pass, the membrane having an upstream side and a downstream side;
at least one solution inlet adjacent said upstream side of said membrane;
at least one solution outlet adjacent said upstream side of said membrane;
at least one solvent outlet adjacent said downstream side of said membrane;
an inlet solution pump upstream of said at least one solution inlet having an inlet solution pump flow rate; and
an outlet solution pump downstream of said solution outlet having an outlet solution pump flow rate.

19- The system of claim 18 wherein said outlet flow rate is less than said inlet flow rate.

20- The system of claim 18 wherein said pumps together exhibit a ratio of the outlet flow rate to the inlet flow rate which remains substantially constant.

21- The system of claim 20 wherein said pumps are mechanically coupled together to keep constant a ratio of speeds of said pumps.

22- The system of claim 21 wherein said pumps are each positive displacement pumps with speeds of said pumps linked together.

23- The system of claim 22 wherein each of said pumps are driven by a common pump drive shaft.

24- The system of claim 22 wherein each of said pumps are turbine pumps with linked speeds.

25- The system of claim 24 wherein each of said pumps are coupled to a common drive shaft.
